(19) United States
(12) Patent Application Publication
(10) Pub. No.: US 2015/0084833 A1
(43) Pub. Date: Mar. 26, 2015

(54) EMBEDDED ANTENNA

(71) Applicant: QUANTA COMPUTER INC., Tao Yuan Shien (TW)

(72) Inventors: Chun-I LIN, New Taipei City (TW); Hui LIN, Taipei City (TW); Ming-Che CHAN, New Taipei City (TW)

(73) Assignee: QUANTA COMPUTER INC., Tao Yuan Shien (TW)

(21) Appl. No.: 14/151,325

(22) Filed: Jan. 9, 2014

(30) Foreign Application Priority Data
Sep. 25, 2013 (TW) 102134595

(51) Int. Cl. H01Q 5/00; H01Q 1/36

(52) U.S. Cl. CPC H01Q 5/0027; H01Q 1/36
USPC 343/905

(57) ABSTRACT

An embedded antenna includes: a metal protrusion portion for providing a first resonance frequency; a co-axial cable for providing a second resonance frequency; and a ground portion. The co-axial cable is fixed and electrically connected to the ground portion. The ground portion is fixed and electrically connected to a system ground plane. The ground portion is electrically connected to the metal protrusion portion.

This application claims the benefit of Taiwan application Serial No. 102134595, filed Sep. 25, 2013, the subject matter of which is incorporated herein by reference.

### BACKGROUND OF THE DISCLOSURE

1. Field of the Disclosure

The disclosure relates in general to an embedded antenna, and more particularly to a multi-band embedded antenna.

2. Description of the Related Art

In the contemporary information society, personal mobile communication products have become popular and brought to the market a lot of commercial opportunities. As to versatile electronic communication devices such as laptops, tablet computers, All-in-one PCs, these electronic communication devices have different antenna design. Moreover, the antenna designer is required to take environmental factors into consideration, so as to achieve the desired characteristic and performance of antennas. Even under the same RF specification, the antenna may be needed to be adjusted according to the environment, and thus can meet the requirement of RF specification for versatile electronic communication devices.

For a personal mobile communication product, a build-in antenna (embedded antenna) is usually located on a place around a display screen (such as an LCD), so that the radiator of the embedded antenna is designed according to the available space surrounding the display screen. For use in the personal mobile communication product, the antenna is required to have powerful function. In view of the current antenna, the lower the operation frequency of the antenna, the larger the antenna. On the other hand, the higher the operation frequency of the antenna, the smaller the antenna.

Thus, it is an issue worthy of being discussed to provide an antenna design that can be used in versatile mobile communication products.

### SUMMARY OF THE DISCLOSURE

The disclosure is directed to a multi-band embedded antenna, wherein a length of an exposed core and/or a gap between the core and a metal protrusion portion may be adjusted for resonance frequency tuning and/or matching.

The disclosure is directed to an embedded antenna for multi-band, wherein a feed position of the core can be adjusted so as to achieve resonance frequency tuning and/or matching of the antenna.

According to an example of the present disclosure, an embedded antenna is provided. The embedded antenna includes: a metal protrusion portion for providing a first resonance frequency; a co-axial cable for providing a second resonance frequency; and a ground portion. The co-axial cable is fixed and electrically connected to the ground portion. The ground portion is fixed and electrically connected to a system ground plane. The ground portion is electrically connected to the metal protrusion portion.

According to another example of the present disclosure, an embedded antenna is provided. The embedded antenna includes: a metal protrusion portion for providing a first resonance frequency; a coupled metal stub for providing a second resonance frequency; a co-axial cable fed into the coupled metal stub, wherein a feed position where the co-axial cable is fed into the coupled metal stub is relative to the first resonance frequency and the second resonance frequency; and a ground portion. The co-axial cable is fixed and electrically connected to the ground portion. The ground portion is fixed and electrically connected to a system ground plane. The ground portion is electrically connected to the metal protrusion portion.

The above and other contents of the disclosure will become better understood with regard to the following detailed description of the preferred but non-limiting embodiment(s). The following description is made with reference to the accompanying drawings.

### BRIEF DESCRIPTION OF THE DRAWINGS

FIG. 1 is a schematic diagram showing a portion of a co-axial cable of an embedded antenna according to the embodiments of the disclosure.

FIG. 2 is a schematic diagram showing an embedded antenna according to a first embodiment of the disclosure.

FIGS. 3A˜3C are schematic diagrams showing an example of an embedded antenna according to a second embodiment of the disclosure.

FIG. 4 is a schematic diagram showing another example of the embedded antenna according to the second embodiment of the disclosure.

FIGS. 5A˜5D are schematic diagrams showing the field pattern and the efficiency of the embedded embodiment according to the embodiments of the disclosure.

### DETAILED DESCRIPTION OF THE DISCLOSURE

The disclosure adopts technical terms which are commonly used by those skilled in the art. If specifically described or defined in the disclosure, some terms should be referred to their description or definition in the disclosure. Technology principles, which are known in the art, are thus omitted for sake of brevity. In addition, elements shown in the figures are provided for exemplary illustration without any intention of limitation to their shape, dimension, and/or scale, and figures are provided for those skilled in the art to understand the disclosure. Thus, the disclosure is not limited thereto.

Embodiments of the disclosure each have one or more technical features. In practice, some or all of the technical features described in any embodiment may be selectively used by those skilled in the art. Alternatively, some of all of the technical features described in these embodiments may be selectively combined by those skilled in the art.

In the following embodiments of the disclosure, the embedded antenna includes a co-axial cable. In convention, the co-axial cable is mainly used for power transmission. However, in the following embodiments of the disclosure, the co-axial cable is not only used for power transmission but also used to affect resonance frequencies of the antenna.

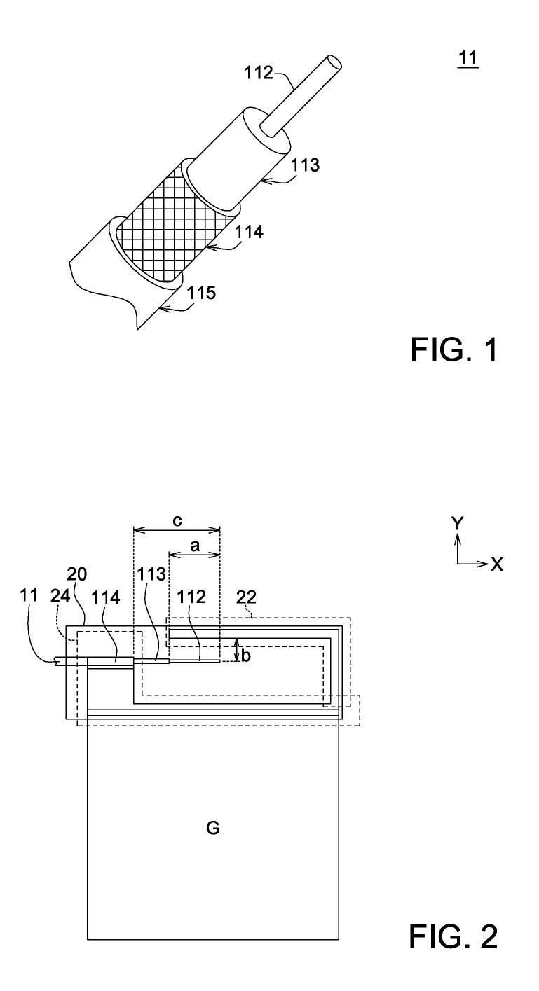

FIG. 1 is a schematic diagram showing a portion of a co-axial cable of an embedded antenna according to an embodiment of the disclosure. The co-axial cable 11 includes a core 112, an insulation layer 113, an outer woven shield 114 (which can be made of metal materials), and a plastic cover 115. The core 112 is exposed outside the insulation layer 113. The core 112 can affect the resonance frequencies of the embedded antenna.

The insulation layer 113 covers the core 112, but does not completely cover the core 112. The insulation layer 113 may be made of Teflon. The outer woven shield 114 covers the insulation layer 113 and the core 112 inside the insulation layer 113. But, the outer woven shield 114 does not completely cover the insulation layer 113.

The plastic cover 115 of the co-axial cable 11 does not completely cover the outer woven shield 114. The exposed outer woven shield 114 may be fixed to and electrically connected to a system ground plane (not shown) of a mobile communication product. The co-axial cable 11 is electrically connected to the system ground plane of the mobile communication product through the outer woven shield 114.

The system ground plane of the mobile communication product can be electrically connected to the outer woven shield 114. Specifically, the outer woven shield 114 of the co-axial cable 11 is connected to the system ground plane of the mobile communication product through, for example, a ground connector (not shown) which may be made of a copper foil tape.

### First Embodiment

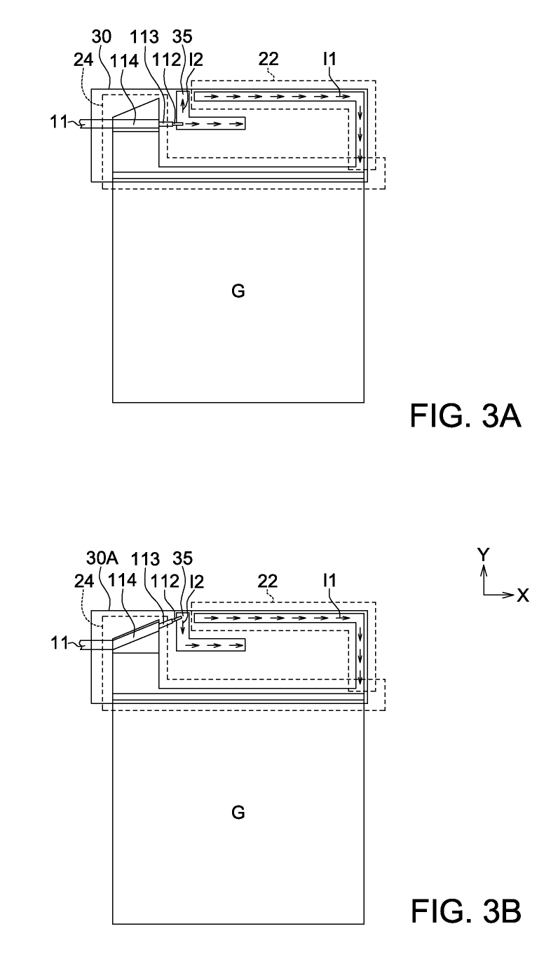

FIG. 2 is a schematic diagram showing an embedded antenna 20 according to a first embodiment of the disclosure. As shown in FIG. 2, the embedded antenna 20 includes: a co-axial cable 11 (details of which can be referred to the co-axial cable in FIG. 1), a metal protrusion portion 22, and a ground portion 24.

The ground portion 24 of the embedded antenna 20 may be fixed to and electrically connected to the system ground plane G. For example, a part of the ground portion 24 of the embedded antenna 20 may be fixed to and electrically connected to the system ground plane G, so that both of them are fixed and electrically connected to each other. Similarly, the metal protrusion portion 22 may be electrically connected to the system ground plane G and the ground portion 24. In fact, the metal protrusion portion 22 and the ground portion 24 are integrated together, while they are described as two separate components here for the sake of explanation.

In addition, as is described above, the outer woven shield of the co-axial cable is fixed to the ground portion 24, thus to be fixed to and electrically connected to the system ground plane G.

The metal protrusion portion 22 is for the resonance of the first frequency band (e.g. 2.4 GHz), i.e. for providing a first resonance frequency. The metal protrusion portion 22 is, for example, as an inverted L-shape. In the first embodiment of the disclosure, by adjusting the pattern of the metal protrusion portion 22, the metal protrusion portion 22 may be resonated at around 2.4 GHz. Adjusting the parameters “a” and “b” may achieve tuning of the resonance frequency (or pattern) in the first frequency band and/or matching.

The parameter “a” is indicative of a portion of the core 112 of the co-axial cable which is extended towards the metal protrusion portion 22 in a horizontal direction. That is, the parameter “a” is the length of the core 112 exposes/protrudes from the insulation layer 113.

The parameter “b” is indicative of a gap between the core 112 of the co-axial cable and the metal protrusion portion 22 in a vertical direction.

In the first embodiment of the disclosure, adjusting the parameter “c” may achieve tuning of the lowest resonance frequency and the pattern in the second frequency band. The parameter “c” is indicative of a sum of the length of the exposed core 112 and the exposed insulation layer 113. That is, the core 112 has a portion (having a length represented by the parameter “c”) extended from the outer woven shield 114, and this portion can affect the resonance frequency of the second frequency band. Slightly adjusting the parameters “c” and “b” may achieve tuning of the resonance frequency in the second frequency band and matching.

Thus, in the first embodiment of the disclosure, by controlling the length (the parameter “a”) of the core (i.e., the length of the exposed portion of the core), the gap (the parameter “b”) between the core and the metal protrusion portion 22, and the length (the parameter “c”) of the core exposed from the outer woven shield, the coupling of the embedded antenna 20 can be controlled, so as to achieve resonance at two frequency bands (e.g. 2.4 GHz and 5 GHz).

As can be seen from FIG. 1 and FIG. 2, the embedded antenna in the first embodiment of the disclosure can be modularized. In this way, mass production is convenient and possible. In addition, the embedded antenna in the first embodiment of the disclosure can be used in different situations. In other words, if the antenna is required to be tuned for different situations, the parameters “a” and/or “b” and/or “c” can be slightly adjusted. Therefore, the embedded antenna in the first embodiment of the disclosure is helpful in mass production, thus reducing the manufacturing cost.

### Second Embodiment

As to the embedded antenna of a second embodiment of the disclosure, adjusting a feed position of the core may tune resonance frequency of two frequency bands and/or matching.

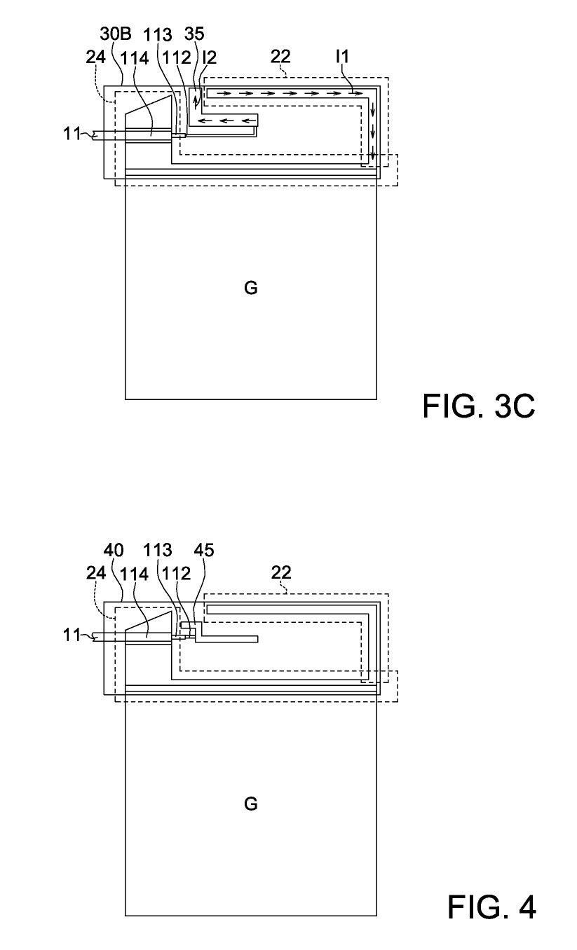

FIGS. 3A˜3C are schematic diagrams showing an example of an embedded antenna according to the second embodiment of the disclosure. As shown in FIGS. 3A˜3C, in tuning, the parameters “a”˜“c” are not adjusted in principle, but rather the feed position of the core of the co-axial cable is adjusted. Detailed description is provided below.

In the second embodiment of the disclosure, the embedded antenna 30 further includes a coupled metal stub 35. In the second embodiment of the disclosure, adjusting the position where the core 112 is fed into the coupled metal stub 35 can tune the resonance frequency of two frequency bands and/or matching. It is made as an example that the coupled metal stub 35 is of an inverted L-shape. The coupled metal stub 35 can be formed on a substrate (not shown).

It is made as an example that, in FIG. 3A, the core 112 is fed into the coupled metal stub 35 at the right angle corner of the coupled metal stub 35. In this way, two current paths I1 and I2 are formed in the embedded antenna 30. The current path I1 is formed in the metal protrusion portion 22, thus providing the resonance of the first frequency band. The current path I2 is formed in the coupled metal stub 35, thus providing the resonance of the second frequency band.

Thus, as can be seen from FIG. 3A, if the feed position of the core 112 is adjusted, the paths I1 and I2 will be changed correspondingly. As a result, resonance frequency tuning of the first and the second frequency bands and/or matching can be achieved.

Similarly, refer to FIG. 3B where the core 112 is fed into an end of the coupled metal stub 35. In this way, two current paths I1 and I2 are formed in the embedded antenna 30A. The current path I1 is formed in the metal protrusion portion 22, thus providing the resonance of the first frequency band. The current path I2 is formed in the coupled metal stub 35, thus providing the resonance of the second frequency band.

Similarly, refer to FIG. 3C where the core 112 is fed into another end of the coupled metal stub 35. In this way, two current paths I1 and I2 are formed in the embedded antenna 30B. The current path I1 is formed in the metal protrusion portion 22, thus providing the resonance of the first frequency band. The current path I2 is formed in the coupled metal stub 35, thus providing the resonance of the second frequency band.

Thus, as can be seen from FIGS. 3A˜3C, in the second embodiment of the disclosure, the position of where the core 112 is fed into the coupled metal stub 35 can be properly selected and controlled, so as to achieve the resonance frequency at two frequency bands (2.4 GHz/5 GHz) and match adjustment. In addition, the feed position of the core is not limited to those disclosed in FIGS. 3A˜3C. Any position on the coupled metal stub 35 can be used as the feed position of the core based on different requirements.

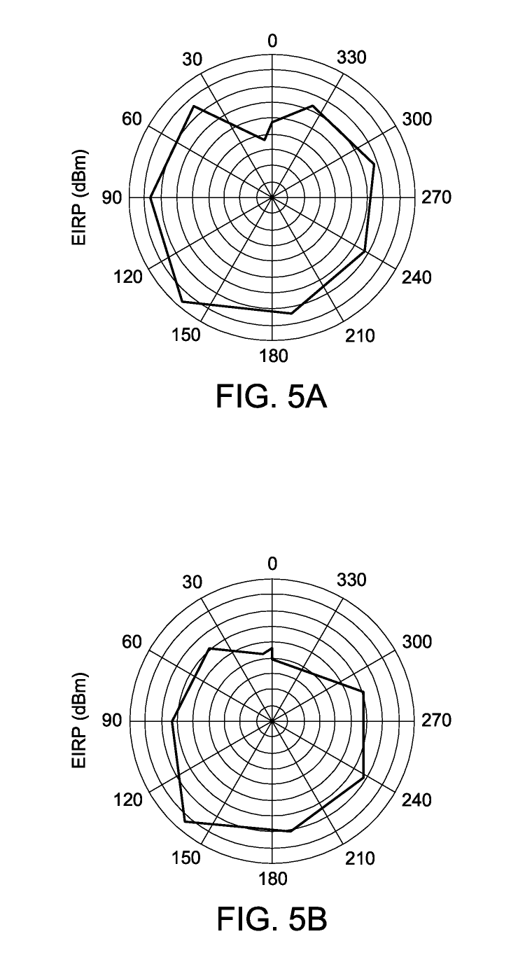

FIG. 4 is a schematic diagram showing another example of the embedded antenna according to a second embodiment of the disclosure. The antennas of FIG. 4 and FIGS. 3A˜3C are different in that the coupled metal stub 35 of the embedded antenna in FIGS. 3A˜3C is of an inverted L-shape, and the coupled metal stub 45 of the embedded antenna 40 in FIG. 4 is of an irregular shape. Similarly, the position where the core is fed into the coupled metal stub can be properly selected and controlled, so as to achieve the resonance frequency tuning of multiple frequency bands and matching.

Besides, the embedded antennas in FIGS. 2˜4 are located on the upper part of the system ground plane G, but this disclosure is not limited thereto. For example, the embedded antenna in other practicable embodiments of the disclosure can be located on the center part, the lower part, or two sides of the system ground plane G, which also is within the disclosure. That is, the embedded antenna in the embodiments of the disclosure can be properly located on any position of the system ground plane according to different requirements.

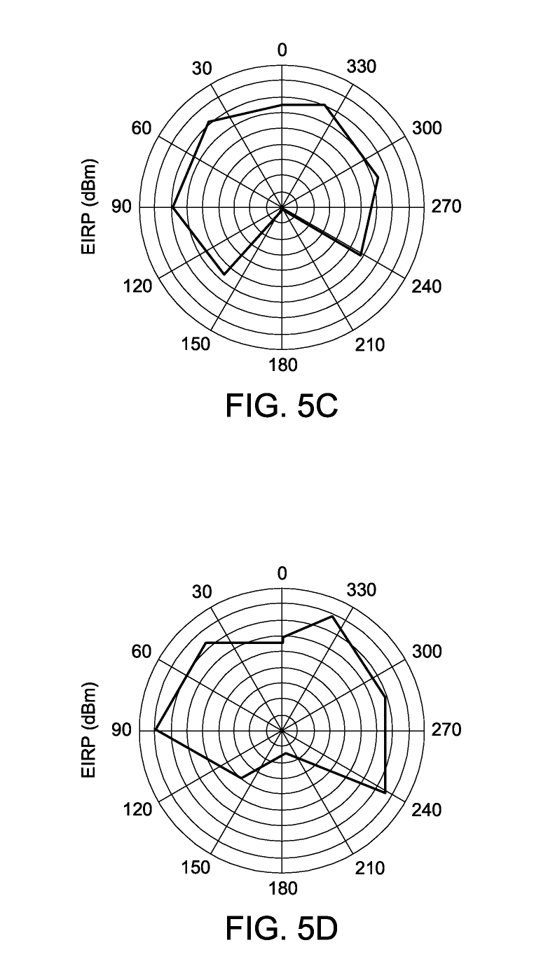

FIGS. 5A˜5D are schematic diagrams showing the field pattern and the efficiency of the embedded antenna according to the embodiments of the disclosure. In FIG. 5A, the embedded antenna of the embodiment of the disclosure is located on a place around a screen (e.g. a 14-inch LCD), and is not blocked by a metallic shield. FIG. 5A shows the field pattern and the efficiency of the embedded antenna which is resonant at a first frequency brand (2.45 GHz). In FIG. 5B, the embedded antenna of the embodiment of the disclosure is located on a place around the screen, and is blocked by a metallic shield. FIG. 5B shows the field pattern and the efficiency of the embedded antenna which is resonant at the first frequency brand (2.45 GHz). In FIG. 5C, the embedded antenna of the embodiment of the disclosure is located on a place around the screen, and is not blocked by a metallic shield. FIG. 5C shows the field pattern and the efficiency of the embedded antenna which is resonant at a second frequency brand (5.5 GHz). In FIG. 5D, the embedded antenna of the embodiment of the disclosure is located on a place around the screen, and is blocked by a metallic shield. FIG. 5D shows the field pattern and the efficiency of the embedded antenna which is resonant at the second frequency brand (5.5 GHz).

As can be seen from FIGS. 5A˜5D, the embedded antenna of the embodiment of the disclosure provides excellent field pattern and efficiency no matter the embedded antenna is operated at either the first or the second frequency bands, and blocked or not blocked by a metallic shield.

From the description mentioned above, according to the two embodiments of the disclosure, resonance frequency tuning of two frequency brands and/or matching can be achieved by changing position or length of the core in different ways (e.g. adjusting an exposed length of the core or an length of the core protruding from the outer woven shield in FIG. 2, or adjusting a feed position of the core of the co-axial cable in FIGS. 3A˜3C or FIG. 4). Thus, the embedded antenna of the embodiments of the disclosure can be used in different environment conditions and/or different mobile communication products (for example, the embedded antenna of the embodiments of the disclosure may be located at a proper position on the system ground plane). In this way, product standardization can be achieved, and manufacturing cost can be reduced because the embedded antenna of the embodiments of the disclosure is suitable for different environment conditions and/or different mobile communication products.

On the other hand, in order to adjust the resonance frequency and/or matching of a convention antenna, the shape of the metal (i.e. the radiator) of the conventional antenna is adjusted. In this way, different products are required to have different shapes of metal, thus failing in providing a single antenna design for versatile product requirements.

While the disclosure has been described by way of example and in terms of the preferred embodiment(s), it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An embedded antenna, including:
a metal protrusion portion for providing a first resonance frequency;
a co-axial cable for providing a second resonance frequency; and
a ground portion, wherein the co-axial cable is fixed and electrically connected to the ground portion, the ground portion is fixed and electrically connected to a system ground plane, and the ground portion is electrically connected to the metal protrusion portion.

2. The embedded antenna according to claim 1, wherein the co-axial cable includes a core, the core has an portion which is exposed, the exposed portion of the core affects the first resonance frequency, the exposed portion of the core is extended towards the metal protrusion portion, and the exposed portion of the core has a length which is adjusted so as to adjust the first resonance frequency.

3. The embedded antenna according to claim 2, wherein a gap between the exposed portion of the core of the co-axial cable and the metal protrusion portion affects the first resonance frequency, and the gap is adjusted so as to adjust the first resonance frequency.

4. The embedded antenna according to claim 2, wherein the co-axial cable further includes an insulation layer, an outer woven shield, and a cover, the exposed portion of the core is exposed outside the insulation layer, the insulation layer has a portion exposed outside the outer woven shield, and the outer woven shield has a portion exposed outside the cover, and the outer woven shield is fixed and electrically connected to the ground portion and the system ground plane, wherein a length sum of a length of the exposed portion of the core and a length of the exposed portion of the insulation layer is adjusted so as to adjust the second resonance frequency.

5. The embedded antenna according to claim 4, wherein the core has another portion which is extended from the cover and is for providing the second resonance frequency.

6. An embedded antenna, including:
a metal protrusion portion for providing a first resonance frequency;
a coupled metal stub for providing a second resonance frequency;
a co-axial cable fed into the coupled metal stub, wherein a feed position where the co-axial cable is fed into the coupled metal stub is relative to the first resonance frequency and the second resonance frequency; and
a ground portion, wherein the co-axial cable is fixed and electrically connected to the ground portion, the ground portion is fixed and electrically connected to a system ground plane, and the ground portion is electrically connected to the metal protrusion portion.

7. The embedded antenna according to claim 6, wherein the co-axial cable includes a core, and the core has an exposed portion which is fed into the coupled metal stub.

8. The embedded antenna according to claim 6, wherein the coupled metal stub is of an inverted L-shape or an irregular shape.

9. The embedded antenna according to claim 6, wherein the feed position where the co-axial cable is fed into the coupled metal stub is adjusted so as to adjust the first resonance frequency and the second resonance frequency
